(19) United States
(12) Patent Application Publication
(10) Pub. No.: US 2017/0015954 A1
(43) Pub. Date: Jan. 19, 2017

(54) RID A BLUE

(71) Applicant: Neil Stern, Naples, FL (US)

(72) Inventor: Neil Stern, Naples, FL (US)

(21) Appl. No.: 14/799,460

(22) Filed: Jul. 14, 2015

(51) Int. Cl. C11D 11/00; C11D 3/00; C11D 1/00

(52) U.S. Cl. CPC C11D 11/0029; C11D 1/00; C11D 3/0005

(57) ABSTRACT

The present invention is related to a de bluing agent for cleaning the engine pipes. It is very helpful in cleaning the bluing of engine pipes in short span of time De bluing agent has detergent oil for cleaning the engine pipe. It has white diamond polish for cleaning the severe bluing from engine pipes. Users just have to start their vehicle engine for 3 minutes and then stop for applying the de bluing agent on engine pipe. No rubbing required in it for removing the bluing from motor cycle pipes. Present invention takes less tune and it lasts a long time on new and old pipes when done properly.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

Field of the Invention

The invention is directed to the field of motorcycle pipe cleaning. More particularly, the invention is a method for removing bluing from motorcycle pipes using a detergent oil and polish.

Background of Invention

Motorcycle exhaust pipes can suffer a variety of burns, scorching, and scratches. Contaminants that come into contact with hot exhaust pipes, such as shoe leather, plastic, denim, and other materials, can detract from their appearance and smell bad when hot. Exhaust pipes can be subjected to such high temperatures that they burn, leaving blue, black, or rainbow discolorations. The high temperature bluing discoloration commonly originates at the neck of the main exhaust pipe near the engine head, where temperatures reach the highest. It takes a little skill and persistent effort to remove blue scorch marks, but it can be done with a good product and proper technique.

The cause of exhaust bluing is usually a lean running engine, exhaust that has been overheated, or simply a cheaper single-walled exhaust pipe. Removing the bluing is relatively easy; however, the cause should be investigated and repaired.

To remove the bluing from motorcycle pipes:

1—Position the motorcycle on its main kickstand on a level surface. For best results, remove the exhaust pipe at the head connection with the appropriate socket and wrench. The header exhaust flange fins or securing bracket can impede the removal of burned scoring. Remove the exhaust pipe mounting brackets and pull the exhaust pipe free of the frame.

2—Mix a solution of mild dish washing soap and water in a bucket. Use a stiff-bristled brush to scrub the entire length of the pipe from the header location to the tailpipe end and the muffler. Wipe the pipe dry with a towel then set it on a workbench.

3—Slide the header pipe flange (or bracket clamp) down the pipe and away from the scorch mark location or remove it completely. Open a jar of “ Blue Job” chrome polish and mix the powder ingredients with water according to the directions until the consistency resembles a thick paste.

4—Apply the “Blue Job” paste onto the flat part of a wood block. With circular motions, scrub the block over the scorched area from the end of the blue discoloration to the front of it. Overlap the front end of the pipe. Concentrate on one section of the pipe at a time. Alternate circular scrubbing strokes with vertical strokes, scrubbing past both ends of the scorched area.

5—Wipe the pipe dry with a clean towel and inspect the surface. If any blue scorch marks remain, apply more paste and continue scrubbing. For a smoother and more even polish, apply the Blue Job paste onto a scouring sponge and rub it into the pipe's surface. Wipe the paste residue off the pipe and buff it dry with a towel. The chrome surface should appear shiny with no discoloration.

6—Align the pipe with the header bracket flange. Insert the mounting bolts or screw on the flange. Realign the pipe mounting brackets and reinsert the mounting bolts into their holes. Tighten all the bolts with the socket and wrench.

The present invention is provided with a better solution for removing bluing from motorcycle pipes by using detergent oil and a polish.

The average motor oil today comes with a standard mix of detergents to prevent the failings of oil filters by attaching to particles that are too small to pt caught in filters. Instead, the detergent holds the particles in the oil so that they don't deposit on engine parts and cause hot spots. Motor oil with detergents include chemicals that aid in trapping particles, dispersant additives that break down coagulating sludge in channels, rust preventers, and alkaline to offset the acidic nature of oil in general as it begins to oxidize.

### BRIEF SUMMARY OF THE INVENTION

In the view of the foregoing disadvantages inherent in the known types of detergent oil now present in the prior art, the present invention provides improved detergent oil. As such, the general purpose of the present invention, which will be described subsequently in greater detail, is to provide a new and improved detergent oil for cleaning motorcycle pipes, which has all of the advantages of the prior art and none of the disadvantages.

It is an objective of the present invention is to provide detergent oil for cleaning bluing from motor cycles pipe.

Another objective of the present invention is to provide a rag for cleaning the motorcycle pipes.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying descriptive matter, in which there are illustrated preferred embodiments of the invention.

Accordingly, the present disclosure includes features and advantages that are believed to enable it to advance the art of placing items on carriers. Characteristics and advantages of the present disclosure described above and additional features and benefits will be readily apparent to those skilled in the art upon consideration of the following detailed description and referring to the accompanying drawings.

### DETAILED DESCRIPTION OF THE INVENTION

The preferred embodiment of the current invention is detergent oil that is used for removing bluing from motorcycle pipes. Detergent oil will work faster on newer motorcycle pipes. It works faster than others non-detergent oils which are currently available in the market. “Maxlife™ SAE 10W-40 HIGH MILEAGE MOTOR OIL” is an example of the detergent oil available on the market having major compounds Heavy Paraffinic Distillate (5.2%) and Zink Dialkyl diphosphate (1.08%). The present invention takes less time and prevents bluing for a longer time on newer motorcycle pipes. No rubbing is required for removing the bluing from motorcycle pipes. Before using this detergent oil on the motorcycle pipes, users should turn on the engine for about 3 minutes until it is hot enough to hear a hissing sound when applied. Then turn off the engine. At that time, users should wear gloves so as not to burn their hands. Severe bluing will need to use a polish with “White Diamonds” containing after the pipes cooled a bit. If “White Diamonds” polish stands in the bottle for a day or two it will separate into two layers, pour out the upper layer into a small bottle carefully. Two pieces of a rag a r e required for removing the bluing from motorcycle pipes. One piece of rag will be used for applying detergent oil, while the other one is for applying the polish.

Bluing is the process when intense heat causes the exhaust pipes to turn a bluish, or sometimes yellow or brown, color.

Polishing the motorcycle exhaust pipes alone is usually not enough to remove the bluing. To remove discoloration from the pipes, the user has to spend a little more time and effort on the exhaust pipes. The subject of the present invention, the use of compounds in detergent oil and polish to remove bluing from motorcycle exhaust pipes, can be used only for chrome pipes, and cannot be used for stainless pipes.

To remove bluing from motorcycle exhaust pipes the user needs:
1. Detergent Oil containing a based compound polyolefin, Heavy Paraffinic Distillate (5.2%) and Zink Dialkyl diphosphate (1.08%).
2. White diamond Polish containing proprietary metal oxide in 30-60%, Solvent naphtha (petroleum). Heavy aliphatic in 30-100%, and Petroleum Distillates, Hydrotreated light in 30-100%.
3. Rags.

Below are the steps for removing bluing from motor cycle pipes.
1. Clean off the motorcycle exhaust pipes- Use a rag to wipe of any debris or dirt on the exhaust pipe.
2. Turn on the engine—Turn the engine on for three (3) minutes.
3. Turn off the engine and wait 3-4 minutes to cool the pipes down
4. Apply the bluing removal product—Apply the detergent oil having a based compound polyolefin , Heavy Paraffinic Distillate (5.2%) and Zink Dialkyl diphosphate (1.08%)on the exhaust pipe of the motorcycle.
5. Thoroughly clean the discolored pipes- Work the removal product into the discolored areas of the pipes in small circular movements.
6. Apply polish for containing proprietary metal oxide in 30-60%, Solvent naphtha (petroleum). Heavy aliphatic in 30-100%, and Petroleum Distillates, Hydrotreated light in 30-100%.
7. Dry the motorcycle exhaust pipe—Just leave the exhaust pipe idle for few minutes.

It is to be understood that the above description is intended to be illustrative, and not restrictive. For example, the above-discussed embodiments may be used in combination with each other. Many other embodiments will be apparent to those of skill in the art upon reviewing the above description.

1. A de bluing agent for cleaning the engine pipes comprising:
a rag,
detergent oil,
white diamond polish.

2. The de bluing agent of claim 1, wherein said rag is used for removing the bluing from engine pipe.

3. The de bluing agent of claim 1, wherein said detergent is used for cleaning the engine pipe.

4. The de bluing agent of claim 1, wherein said white diamond polish is used for cleaning old engine pipes.

5. A method for removing bluing from motorcycle exhaust pipes comprising the following steps:
Cleaning off the motorcycle exhaust pipes of debris with first rag,
Turning on the engine for 3-4 minutes,
Turning off the engine and leaving it for 3-4 minutes to cool down,
Applying detergent oil with second rag,
Thoroughly cleaning the discolored motorcycle exhaust pipes,
Letting the pipes cool down for 3 minutes,
Applying a polish, and
Drying the motorcycle exhaust pipes.

6. (canceled)

7. (canceled)

8. The method as claimed in claim 5, wherein said bluing removing product is detergent oil comprised of a based compound polyolefin, Heavy Paraffinic Distillate 5.2%, and Zink Dialkyl diphosphate 1.08%.

9. The method as claimed in claim 5, wherein said polish consists of proprietary metal oxide in 30-60%, Solvent naphtha (petroleum), Heavy aliphatic in 30-100%, and Petroleum Distillates, Hydrotreated light in 30-100% applied on the motorcycle exhaust pipes after the pipes have cooled off.
